(19) United States
(12) Patent Application Publication
(10) Pub. No.: US 2022/0011089 A1
(43) Pub. Date: Jan. 13, 2022

(54) WIDE FIELD-OF-VIEW MICHELSON FOR SHEAROGRAPHY

(71) Applicant: BAE Systems Information and Electronic Systems Integration Inc., Nashua, NH (US)

(72) Inventors: Jacob D. Garan, Honolulu, HI (US); Mark S. Branham, Oro Valley, AZ (US); Christopher E. Saxer, Southport, NC (US)

(73) Assignee: BAE Systems Information and Electronic Systems Integration Inc.

(21) Appl. No.: 16/924,876

(22) Filed: Jul. 9, 2020

(51) Int. Cl. G01B 9/02

(52) U.S. Cl. CPC G01B 9/02022; G01B 9/02068

(57) ABSTRACT

A splitting and recombining optical component with an increased field of view while maintaining or only minimally increasing the space requirements therefor is provided. Further, the combination of the changes in physical geometry and refractive index of the beam splitting and recombining optical device can increase the field of view of a system while maintaining, or even reducing, the mass of the system in which the present beam splitting and recombining optic may be utilized

### STATEMENT OF GOVERNMENT INTEREST

The invention was made with United States Government support under Contract No. N000 14-16-C-3059, U.S. Navy awarded by the United States Navy. The United States Government has certain rights in this invention.

### TECHNICAL FIELD

The present disclosure relates generally to the field of beam splitting or beam manipulation. More particularly, in one example, the present disclosure relates to an improved splitting surface geometry and optical medium to increase the field of view for beam splitting applications. Specifically, in another example, the present disclosure relates to an improved beam splitting surface and medium choice that allow increased field of view to a previously unattainable range while maintaining or reducing the mass of the splitting surface and medium.

### BACKGROUND

Beam splitting applications, particularly those used in interferometric imaging applications like shearography, typically involve an optical beam or wavefront to be split into multiple directions and then recombined in order to measure the resulting interference pattern. To accomplish this splitting and recombining, it is common to use an optical device such as a beam splitter to both split and recombine the beam to allow for the proper measurements to be taken. In addition, the optical device, such as the beam splitter, is typically used in conjunction with one or more mirrors to direct the beam. Each of these components requires a physical space to properly position and align these components to achieve maximum accuracy and repeatability. This arrangement and space requirement can limit the field of view for a system employing such optical components.

In instances where the beam splitting surface is immersed in an optical medium, such as optical glass, the refractive index of the optical medium may further place a limit on the field of view of the system.

To increase the viewable area in such a system, current solutions tend to include increasing the size of the optical components, thus requiring additional space, not only to account for the increased size of the components but to further account for proper spacing between the individual components to maintain accuracy and repeatability in the system.

### SUMMARY

The present disclosure addresses these and other issues by providing a splitting and recombining optical component with an increased field of view while maintaining or only minimally increasing the space requirements therefor. Further, the combination of the changes in physical geometry and refractive index of the beam splitting and recombining optical device can increase the field of view of a system while maintaining, or even reducing, the mass of the system in which the present beam splitting and recombining optic may be utilized.

In one aspect, an exemplary embodiment of the present disclosure may provide a method of interferometry comprising: generating a light beam into an interferometer having an increased field of view; directing the light beam to a first side of a splitting surface of a beam splitter within the interferometer, the beam splitter having a height and a width, wherein the height of the beam splitter is greater than the width of the beam splitter and the increased field of view of the interferometer is accomplished by the height of the beam splitter being greater than the width of the beam splitter; dividing the light beam into a first arm and a second arm via the splitting surface; reflecting the first arm of the light beam off a first mirror back to a second side of the splitting surface; reflecting the second arm of the light beam off a second mirror back to the second side of the splitting surface; recombining at least a portion of the first arm of the light beam with at least a portion of the second arm of the light beam; directing the recombined portions of the first and second arms of the light beam to a detector; and producing an interference pattern from the recombined portions of the first and second arms of the light beam. This exemplary embodiment or another exemplary embodiment may further provide wherein the height of the beam splitter is at least twice the width of the beam splitter. This exemplary embodiment or another exemplary embodiment may further provide wherein the beam splitter further comprises: a length equal to the width of the beam splitter. This exemplary embodiment or another exemplary embodiment may further provide wherein the beam splitter further comprises: an optical medium having the splitting surface immersed therein. This exemplary embodiment or another exemplary embodiment may further provide increasing the field of view of the interferometer by increasing a refractive index of the optical medium. This exemplary embodiment or another exemplary embodiment may further provide angling one of the first mirror and the second mirror to introduce interference patterns into a wavefront of the light beam.

In another aspect, an exemplary embodiment of the present disclosure may provide an interferometer comprising: a light source operable to deliver a light beam into the interferometer; a beam splitter having a splitting surface immersed in an optical medium, a height, and a width, wherein the height of the beam splitter is greater than the width of the beam splitter; a first mirror; a second mirror; and a detector. This exemplary embodiment or another exemplary embodiment may further provide wherein the light source further comprises: a laser generator operable to deliver a coherent laser beam into the interferometer. This exemplary embodiment or another exemplary embodiment may further provide wherein the height of the beam splitter is at least twice the width of the beam splitter. This exemplary embodiment or another exemplary embodiment may further provide an increased field of view via the height of the beam splitter being greater than the width of the beam splitter. This exemplary embodiment or another exemplary embodiment may further provide an increased field of view via an increased refractive index of the optical medium having the splitting surface immersed therein. This exemplary embodiment or another exemplary embodiment may further provide an increased field of view via both the height of the beam splitter being greater than the width of the beam splitter and an increased refractive index of the optical medium having the splitting surface immersed therein. This exemplary embodiment or another exemplary embodiment may further provide wherein one of the first mirror and the second mirror is movable to introduce an interference pattern into a wavefront of the light beam. This exemplary embodiment or another exemplary embodiment may further provide wherein the splitting surface further comprises: a first splitting surface operable to direct a first portion of the light beam 90° to one side of the beam splitter and further operable to allow a second portion of the light beam to travel through the first splitting surface. This exemplary embodiment or another exemplary embodiment may further provide wherein the beam splitter further comprises: a second splitting surface behind the first splitting surface operable to recombine the first portion of the light beam with the second portion of the light beam after the first portion of the light beam reflects off of the first mirror and the second portion of the light beam reflects off of the second mirror.

In yet another aspect, an exemplary embodiment of the present disclosure may provide a beam splitter comprising: a splitting surface immersed in an optical medium; a top surface connected to at least one side; a bottom surface connected to the at least one side and spaced apart from the top surface by the at least one side; a height defined by the distance from the top surface to the bottom surface; and a width defined by a width of the at least one side; wherein the height of the beam splitter is greater than the width of the beam splitter. This exemplary embodiment or another exemplary embodiment may further provide wherein the height is at least twice the width of the at least one side. This exemplary embodiment or another exemplary embodiment may further provide an increased field of view via the height of the beam splitter being greater than the width of the beam splitter. This exemplary embodiment or another exemplary embodiment may further provide an increased field of view via an increased refractive index of the optical medium having the splitting surface immersed therein. This exemplary embodiment or another exemplary embodiment may further provide an increased field of view via both the height of the beam splitter being greater than the width of the beam splitter and an increased refractive index of the optical medium having the splitting surface immersed therein.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is an overhead schematic view of a prior art beam splitting system.

FIG. 2A (FIG. 2A) is an isometric view of a prior art cube beam splitter.

FIG. 2B (FIG. 2B) is an overhead plan view of a prior art beam splitter.

FIG. 3 (FIG. 3) is an overhead schematic view of a beam splitting system according to one aspect of the present disclosure.

FIG. 4A (FIG. 4A) is an isometric view of a beam splitter according to one aspect of the present disclosure.

FIG. 4B (FIG. 4B) is an overhead plan view of a beam splitter according to one aspect of the present disclosure.

FIG. 5A (FIG. 5A) is an overhead plan view of a beam splitter with a view of the prior art beam splitter superimposed thereon, according to one aspect of the present disclosure.

FIG. 5B (FIG. 5B) is a side elevation view of a beam splitter according to one aspect of the present disclosure.

FIG. 6A (FIG. 6A) is an overhead plan view of a beam splitter according to one aspect of the present disclosure showing the marginal ray paths un an unfolded view commonly referred to as a Tunnel Diagram.

FIG. 6B (FIG. 6B) a side elevation view of a beam splitter Tunnel Diagram according to one aspect of the present disclosure assuming a beam splitter medium with a refractive index of n=1.

FIG. 7A (FIG. 7A) is an overhead plan Tunnel Diagram view of an alternate embodiment of a beam splitter according to one aspect of the present disclosure with regards to increasing refractive index.

FIG. 7B (FIG. 7B) a side elevation view of an alternate embodiment of a beam splitter according to one aspect of the present disclosure.

FIG. 8 (FIG. 8) is a flow chart of an exemplary method according to one aspect of the present disclosure.

Similar numbers refer to similar parts throughout the drawings.

### DETAILED DESCRIPTION

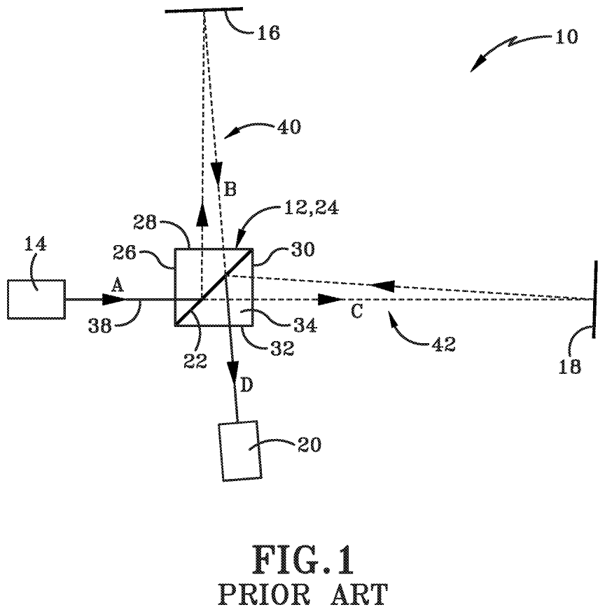

With reference to FIG. 1, a prior art beam splitting system is shown and generally indicated as reference 10. This prior art system, as shown, in a common system used for interferometry and is known as a Michelson interferometer. Although shown and described herein as a Michelson interferometer, this prior art beam splitting system 10 could be any known beam splitting system that utilizes a beam splitter, such as cube beam splitter 12. It will therefore be understood that the example of the Michelson interferometer used herein as a representative example.

The prior art beam splitting system 10 may include a beam splitter 12, which may be a cube beam splitter 12, a light source 14, a first mirror 16, a second mirror 18 and a detector 20. In such a prior art system 10, a light beam 38 may be generated from the light source 14 and directed through the beam splitter 12 off of the first and second mirror 16, 18 and ultimately ending at detector 20 following beam paths A, B, C and D depicted in FIG. 1 and discussed further herein.

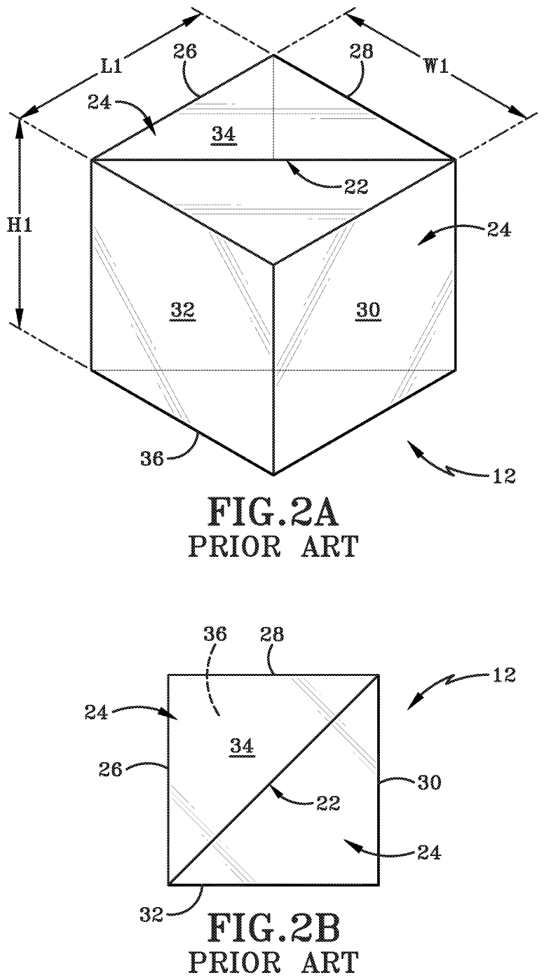

With reference to FIGS. 2A and 2B, a prior art cube beam splitter 12 is shown having a splitting surface 22 immersed within an optical medium 24. According to one aspect, the optical medium 24 may be standard optical glass or another similar material which may include the splitting surface 22 therein. Cube beam splitter 12 may be manufactured or assembled through any known method or means including manufactured as a pair of wedges and combined at the beam splitting surface 22.

This prior art cube beam splitter 12 may include a first side 26, a second side 28, a third side 30 and a fourth side 32. Each of first, second, third and fourth sides 26, 28, 30 and 32 may be any side of beam splitter 12. However, for simplicity and clarity in this disclosure, first side 26 may be the side of cube beam splitter 12 facing the light source 14 and may further be spaced apart from third side 30, which may be the side facing away from light source 14. Similarly, second side 28 may be spaced apart from fourth side 32 and may be defined as the side out of which the first arm 40 passes, as discussed further herein.

Cube beam splitter 12 may also include a top surface 34 spaced apart from a bottom surface 36. It is generally understood that interferometry systems, such as prior art system 10, operate in a single plane; i.e., the light beam 38 stays on the same plane as it travels through the system 10. Accordingly, top surface 34 may then be the surface of cube beam splitter 12 disposed above the plane in which the light beam 38 is traveling while bottom surface 36 may be the surface of cube beam splitter 12 disposed below that plane.

As best seen in FIG. 2A, where beam splitter 12 is a cube beam splitter 12, the dimensions thereof may include a height, indicated in FIG. 2A as H1, and representing the distance between the top and bottom surfaces 34 and 36. Beam splitter 12 may also have a length, indicated in FIG. 2A as L1, representing the distance between second side 28 and fourth side 32, and a width indicated in FIG. 2A as W1 and representing the distance between first side 26 and third side 30. All of these dimensions, H1, L1, and W1 are of equal proportions, thus defining the beam splitter 12 as a cube beam splitter 12. As discussed further below, the use of a cube beam splitter 12 in a prior art system is common but limits the field of view of the system 10 based on the physical geometry creating outermost limits at the corners of cube beam splitter 12.

With continued reference to FIG. 1, FIG. 2A, and FIG. 2B, the additional components of the prior art beam splitting system 10, namely, light source 14, first mirror 16, second mirror 18 and detector 20 may be standard and commonly used optical components in such a system 10. Where, as provided in the example herein, the beam splitting system 10 is a Michelson interferometer, light source 14 may be a laser generator or other commonly used light source generator that is capable of generating a coherent light beam 38 across any appropriate band of the electromagnetic spectrum. According to one aspect, light source 14 may include other optical components such as mirrors, prisms, collimators, or the like as necessary to create and direct light beam 38 outward therefrom and towards the beam splitter 12.

First and second mirrors 16 and 18 may be standard optical mirrors having a reflective coating, or may alternatively be formed from reflective material. Accordingly, mirrors 16 and 18 may be manufactured from any suitable material using known methods and coated with reflective layer. As discussed further below, mirrors 16 and 18 may be operable to reflect the light beam 38 through system 10 as desired and dictated by the specific implementation thereof. As in the example shown in FIG. 1 where system 10 is a Michelson interferometer, the light beam 38 may be reflected to and from the beam splitter 12 along light paths B, C, and D.

Detector 20 may be any type of optical detector suitable for the desired implementation of system 10. According to one aspect, detector 20 may be a focal plane array, a camera, or a similar imaging device having one or more light sensing pixels contained therein. According to another aspect, detector 20 may be any other suitable imaging device or detector that can receive and/or record the light beam 38 as it passes through system 10.

Splitting surface 22 may be an optical coating or other surface or structure immersed within optical medium 24 that may reflect at least a portion of light beam 38 while allowing at least another portion of light beam 38 to pass therethrough. Splitting surface 22 may extend diagonally across the entire beam splitter 12 and have the same height H1 as beam splitter 12. For example, splitting surface 22 may extend from the corner formed between first side 126 and fourth side 132 to the corner formed between second side 128 and third side 130. As shown and used in the example Michelson interferometer, splitting surface 22 may be dual sided such that light beam 38 may be split as it passes through splitting surface in one direction and reflected as light beam 38 encounters the splitting surface 22 from the opposite direction.

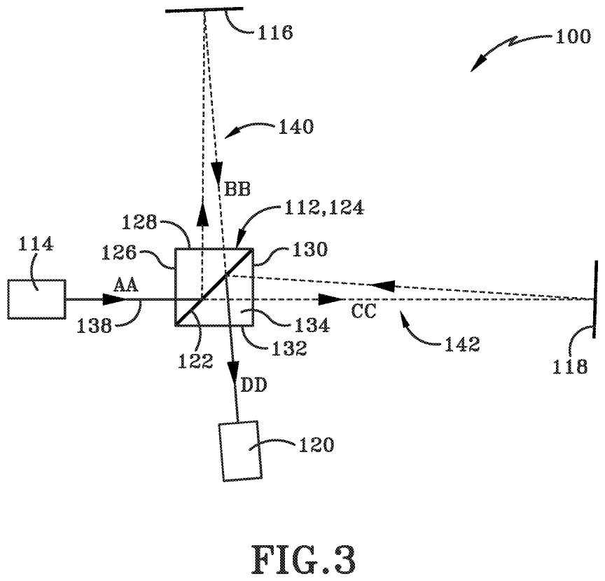

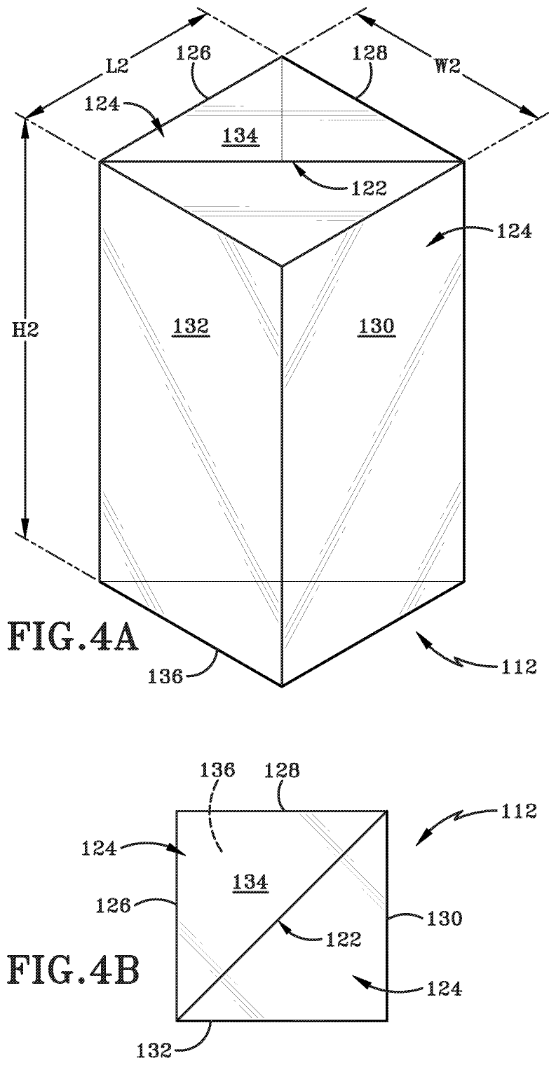

With reference to FIGS. 3, 4A and 4B, a representative example of a beam splitting system is shown and generally indicated at Reference 100. As with the prior art system 10, beam splitting system 100 is being shown as an exemplary Michelson interferometer; however, the improvements and modifications thereto, specifically to the beam splitter 112, as discussed further herein, may be equally applicable to other beam splitting systems and are not limited to use in interferometry applications or in a Michelson interferometer alone. As FIG. 1 and FIG. 3 are overhead schematic views of exemplary Michelson interferometers as beam splitting systems 10, 100 they appear to be identical; however, the differences and modifications to system 100 relative to prior art system 10 will be discussed more thoroughly and completely herein.

Beam splitting system 100 may include a beam splitter 112, a light source 114, a first mirror 116, a second mirror 118, and a detector 120. As with prior art system 10, beam splitting system 10 may be configured to allow a light beam 138 to travel along beam paths AA, BB, CC and DD such that light beam 138 may be split and recombined as it moves through system 100.

With reference to FIG. 4A and FIG. 4B, beam splitter 112 is shown and described herein. As with beam splitter 12, beam splitter 112 may have a splitting surface 122 immersed in an optical medium 124 and may further have a first side 126, a second side 128, a third side 130 and a fourth side 132. First side 126 and third side 130 may be spaced apart and opposite each other while second side 128 and fourth side 132 may be likewise spaced apart and opposite each other. Each of first, second, third and fourth sides 126, 128, 130 and 132 may be any side of beam splitter 112. However, for simplicity and clarity in this disclosure, first side 126 may be defined as the side facing light source 114, as discussed further herein, with second side 128 facing first mirror 116, third side 130 facing second mirror 118, and fourth side 132 facing the detector 120, as depicted and oriented in FIG. 3.

Beam splitter 112 may further include a top surface 134, which may, similar to beam splitter 12, be the surface oriented above the plane upon which light beam 138 travels while a bottom surface 136 of beam splitter 112 may be spaced apart from the top surface 134 and may be the surface oriented below the plane upon which the light beam 138 travels.

Beam splitter 112 may have a height H2 defined as the height of any given side of the first side 126, second side 128, third side 130 and/or fourth side 132 (also represented as the distance between the top and bottom surfaces 134 and 136). Beam splitter 112 may further have a length, shown in FIG. 4A as L2, representing the distance between second and fourth sides 128 and 132, and a width, shown in FIG. 4A as W2 and representing the distance between first and third sides 126 and 130. As it relates to beam splitter 12, the beam splitter 112 may be substantially taller in that H2 may be greater than H1 at any side of beam splitter 112. It is contemplated that L2 and W2 may be equal to each other and of similar or equal dimensions to L1 and W1 of beam splitter 12. In other words, the main difference between the physical geometry of beam splitter 12 and beam splitter 112 is that beam splitter 12 may be best described as a cube beam splitter 12 while beam splitter 112 may be best described as a rectangular prism. The advantages of using a rectangular prism in system 100 are discussed further below.

Splitting surface 122 may be substantially similar to splitting surface 22 in that it may extend diagonally across beam splitter 112 and have the same height H2. Splitting surface 122 may be a surface that allows at least a portion of light beam 138 to be reflected ninety degrees from its direction of origin while allowing at least another portion of light beam 138 to pass therethrough. Further, splitting surface 122 may likewise be two-sided in that portions of light beam 138 hitting either side of splitting surface 122 may be reflected or permitted to pass therethrough as dictated by the desired implementation. As used within the example of a Michelson interferometer, splitting surface 122 may allow light beam 138 to be split into a first arm 140 and a second arm 142 and then recombined as the light beam 38 encounters the opposite side of splitting surface 122.

Similar to medium 24, medium 124 may be any suitable optical medium but may include optical glass. Overall, beam splitter 112 may be formed or constructed using any known method including the joining of multiple wedges and/or multiple elements similar to beam splitter 12.

The remaining components of splitting system 100, namely light source 114, first mirror 116, second mirror 118 and detector 120 may be substantially similar to their counterparts from splitting system 10. Specifically, light source 114 may be substantially similar to light source 14 in that it may be a similar component and/or, according to one aspect, may be the same component with beam splitter 112 substituted for beam splitter 12 within system 10. First mirror 116 and second mirror 118 may likewise be similar or identical to mirrors 16 and 18, and may be any standard optical mirror or similar device operable to reflect light beam 138 as dictated by the desired implementation. Similarly, detector 120 may be substantially similar or identical to detector 20 of beam splitting system 10.

Each of these components 114, 116, 118 and/or 120 may be slightly modified in that the additional field of view provided by the rectangular shape of beam splitter 112 may require adjustments to the size and/or placement of light source 114, first mirror 116, second mirror 118 and/or detector 120 such that they may be scaled up to properly handle system 100 having an increased field of view. Otherwise, these components 114, 116, 118 and/or 120 may be substantially identical to their counterparts from splitting system 10.

Having thus described the elements and components of system 100, the operation thereof will now be discussed.

The operation of system 100 is discussed herein with references to that system 100 and to the various components thereof, however, it will be understood that certain components, for example light source 114, may be substituted with similar components, e.g. light source 14, without substantially altering the operation of system 100. It will be further understood that the operation of system 100 is being described according to the exemplary Michelson interferometer, however, when beam splitter 112 is used with other systems or in other applications, the operation of those systems may differ from what is described herein. Thus, the operation of system 100 is a representative example and not a limiting use thereof.

With reference to FIGS. 1 through 5B, when performing interferometry, a light beam, such as light beam 138 is generated and passed through a beam splitter where it is separated into a first arm 140, which consists of at least a portion of the light beam 138 which is reflected off splitting surface 122, and a second arm 142 consists of at least another portion of light beam 138 which passes through splitting surface 122. Each arm is directed to a mirror or reflective surface such as first mirror 116 and second mirror 118. The light beam 138 then reflects off of these surfaces; e.g. mirrors 116 and 118 before returning to the splitting surface 122. From there, the portion of light beam 138 traveling along beam path BB in first arm 140 interacts with the first side of the splitting surface 122 and passes therethrough while the light reflected off the second mirror 118 travels back along beam path CC in second arm 142 and encounters the opposite side of splitting surface 122 before reflecting ninety degrees and being recombined with the first portion of light beam 138. This recombined beam now travels down beam path DD and into detector 120.

While keeping with the exemplary usage herein of performing interferometry, the physical geometry of the beam splitter employed in performing interferometry provides a limited or a finite field of view based to the system. Interferometry is a form of non-destructive testing commonly used to measure minute displacements and refractive index changes caused by surface irregularities of an object. Further, interferometry can be used to detect objects buried within a substrate through these same minute changes in the surface of the substrate.

Typically, interferometry is performed, in relevant part, through the splitting and recombining of the light beam 138 into first and second arms 140 and 142, which travel a different optical path (e.g. beam path BB and path CC) before being recombined and directed to the detector 120. These different beam paths BB and CC produce interference in the light beam 138 which can provide information about the differences between the reflective surfaces. Therefore, when used in interferometry, it is common that light beam 138 may be first directed off of a separate surface, such as a ground surface or a surface of an object being tested, before encountering the beam splitter 112. Thus, the field of view of the testing surface is limited by the physical geometry of the beam splitter 112 in that any portions of light beam 138 that pass beyond the outermost edges of beam splitter 112 will not be captured by the system 100 and will therefore not reach the detector 120 where it can be measured and/or processed. Further, the field of view limitation affects the size of the area of the test target that can be tested at any specific time.

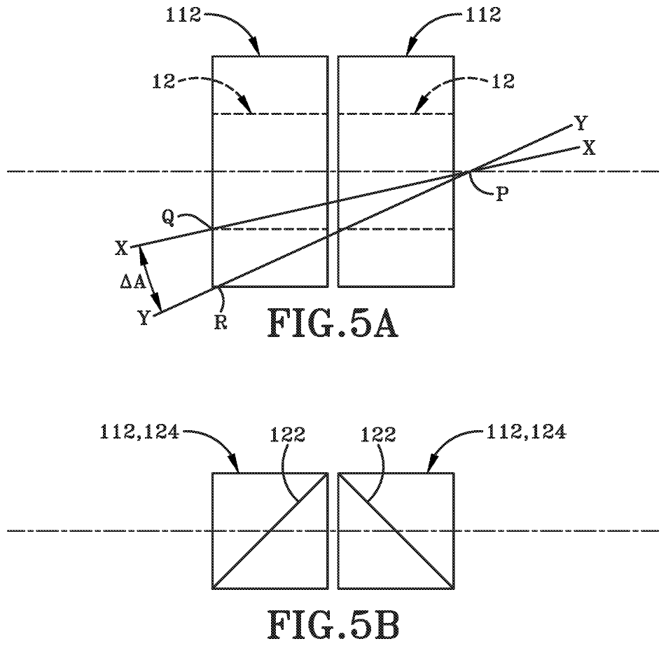

By increasing the height H2 of beam splitter 112 (and splitting surface 122 along with it) relative to beam splitter 12, the field of view thereof is likewise increased. With reference to FIGS. 5A and 5B, the change in field of view is illustrated in FIG. 5A as AA, which represents the change in the field of view based on the physical geometry of beam splitter 112 compared to prior art beam splitter 12. Specifically, as seen in FIG. 5A, the dashed lines indicate the prior outermost boundaries of beam splitter 12 while the solid rectangular lines indicate the outermost boundaries of the sides of beam splitter 112. The dash-dot line extending through beam splitter 112 in FIGS. 5A and 5B represents the centerline of the beam splitter 112.

It is noteworthy that the point Q is the intersection of line XX with the corner of the cube beam splitter 12 represented by the dashed lines in FIG. 5A. Similarly, point R represents the intersection of line YY with the outermost boundary of beam splitter 112. Thus, comparing line XX to line YY, the slope from point P to point R is much steeper than from point P to point Q, indicating a wider field of view. The difference in slope between these two imaginary lines is indicated as AA and represents the increased field of view provided by the rectangular shape of beam splitter 112 as compared to cube beam splitter 12.

As seen in FIG. 5B, a top view of beam splitter 112 is shown to further reinforce the idea that the increased height of beam splitter 112 represents a change in physical geometry in a single direction, which allows beam splitter 112 to have a nearly identical footprint relative to cube beam splitter 12 in that the width W2 and length L2 of beam splitter 112 may be identical to the width W1 and length L1 of cube beam splitter 12 while the height H2 of beam splitter 112 may be greater than the height H1 of cube beam splitter 12. According to one aspect, height H2 of beam splitter 112 may be two times the height H1 of beam splitter 12. According to another aspect, height H2 of beam splitter 112 may be greater than twice the height H1 of beam splitter 12. According to another aspect, height H2 may be greater than the height of H1 by any factor greater than 1 in order to increase the field of view, as discussed herein.

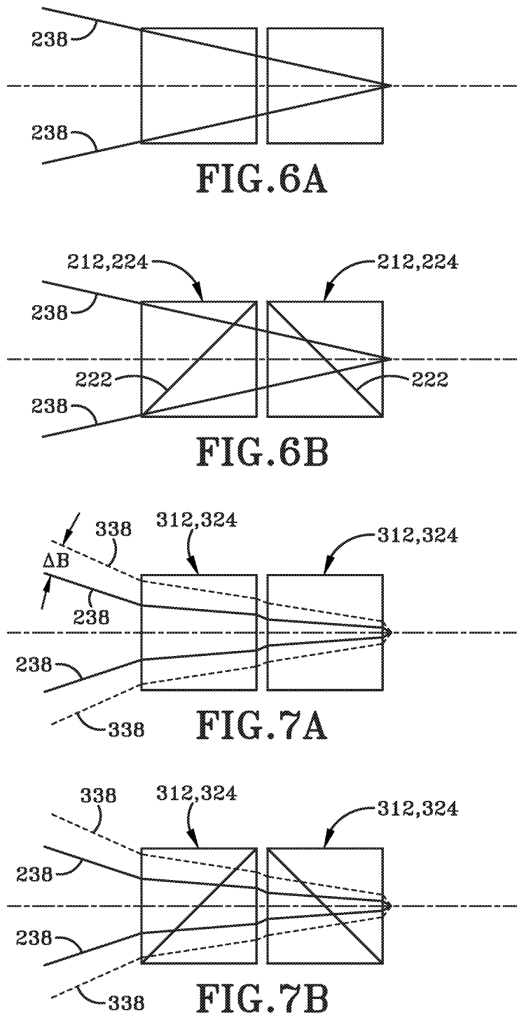

With reference to FIG. 6A through FIG. 7B, an additional modification to beam splitter 12 may be made to further increase the field of view of the beam splitting system 10. Specifically, an optical medium, such as optical medium 24, 124 may be selected having a higher than typical refractive index to maximize the field of view. The refractive index is a measure of the speed at which light travels through a material and applies across the full electromagnetic spectrum. As the speed of light traveling through the material changes based on the composition of that material, the direction of light (refraction) may be affected in a known and/or calculable manner. The refractive index of a material is expressed as a ratio of the velocity of the light in a vacuum versus the velocity of the light in that particular material. Therefore, a ratio of 1:1 indicates light moves at the same speed through the material as it does through vacuum and would indicate zero refraction, i.e. no bending of the light path is it moves through the material. A higher ratio, such as 1.5 for example, indicates that light moves 1.5 times faster through a vacuum than it does through the specific medium. Thus, the higher the refractive index of a material the slower light travels through that material relative to light traveling through a vacuum. This results in more refraction or bending of the light as it enters and moves through the material.

FIGS. 6A and 6B show a representative beam splitter indicated as beam splitter 212, which may be a cube beam splitter, a rectangular prism, or any other suitable shaped beam splitter utilizing a splitting surface 222 immersed in an optical medium 224. FIG. 6A represents a side view of such a beam splitter 212 while FIG. 6B represents the top view thereof, showing the splitting surface 222 immersed within the optical medium 224. The representative beam splitter 212 in FIGS. 6A and 6B represents an optical medium 224 having a refractive index of approximately 1, meaning light is not bent or is minimally bent as it enters and moves through the optical medium 224. Commonly, this is viewed as a chosen solution in optical mediums as the beam path is essentially unaltered and therefore directed to the desired point repeatedly and reliably. The downside to using an optical medium 224 with a low refractive index is that the system is limited in field of view by the physical geometry of the beam splitter 212. As discussed previously herein, increasing the size of beam splitter 212 may help expand the field of view by itself, but that increase in size also increases the weight and space requirements for beam splitter 212.

With reference now to FIGS. 7A and 7B, a representative and exemplary beam splitter is shown and indicated at reference 312, likewise having a splitting surface 322 immersed in an optical medium 324. In the examples shown in FIG. 7A and FIG. 7B, the optical medium 324 may have a higher than typical refractive index. According to one example, this may be a refractive index on a magnitude of one and a half to two times higher than a typical application such as that shown with beam splitter 212. According to one non-limiting example, the refractive index of optical medium 324 may be approximately 1.9.

As seen in FIGS. 7A and 7B, the light beam 338 moves more slowly through optical medium 324 such that it is refracted further and increases the field of view of a system such as a beam splitting system 10 or 100 utilizing beam splitter 312 with a higher refractive index. Specifically, the solid lines beam path 238 indicates the field of view of an optical medium such as optical medium 224 from FIGS. 6A and 6B while the path is shown affected by the higher indexed optical medium 324. The beam path 238 depicted in FIG. 7A and FIG. 7B shows a much smaller field of view while the dashed line represents the path of a beam traveling through an optical medium 324 with a higher refractive index. The difference in the field of view from beam path 238 to 338 is indicated in FIG. 7A as ΔB, which represents the change in field of view between the two optical mediums.

In effect, increasing the refractive index of the optical medium used in a beam splitter such as beam splitters 12, 112, 212 and/or 312 moves the “aperture” of the system closer to the viewing eye. Accordingly, the field of view increases. The physical edges of the beam splitter act as vignetting apertures that limit the field of view. By increasing the refractive index, the reduced thickness, or the physical thickness divided by the refractive index, decreases. The reduction of reduced thickness between the input and output apertures allows for light rays with steeper angles of incidence to pass through without vignetting on the apertures. In other words, by changing the physical geometry of the aperture and by moving the aperture closer to the viewing device, the field of view increases in size. Changing the physical geometry of the beam splitter from a cube, such as beam splitter 12, to a rectangular prism, such as beam splitter 112 and/or increasing the refractive index of the optical medium, such as with optical medium 324, has a similar effect of increasing the field of view for a beam splitting system such as system 10 and/or 100. Doing both increases the field of view even further.

Additionally, the increase in refractive index of the optical medium 324 may allow for thinner and/or smaller beam splitters 12, 112, 212, and/or 312 to be utilized. If done in conjunction with using a rectangular beam splitter (e.g. beam splitter 112), the reduction in size may allow the system 100 to maintain its weight or may even result in a reduction in weight for the system, while still allowing for the additional height H2 of beam splitter 112.

Accordingly, the two improvements discussed herein, namely the increased height of beam splitter 112 relative to beam splitter 12, and the increased refractive index of optical medium 324 relative to optical medium 224, each by themselves may increase the field of view of a beam splitting system such as system 10 and/or 100 as discussed herein. However, used in combination, the maximum field of view for such a system 10, 100 may be realized in the system.

Once again, as discussed herein as used with a Michelson interferometer, it will be understood that the improvements to beam splitter 12 either through the changes in physical geometry such as with beam splitter 112, the increased refractive index of the optical medium such as optical medium 324, or a combination of both may be readily adapted and utilized by any system employing a beam splitter device and is not limited to applications of a Michelson interferometer.

Having thus described the operation of system 100 generally in one example, an exemplary method of use will now be described.

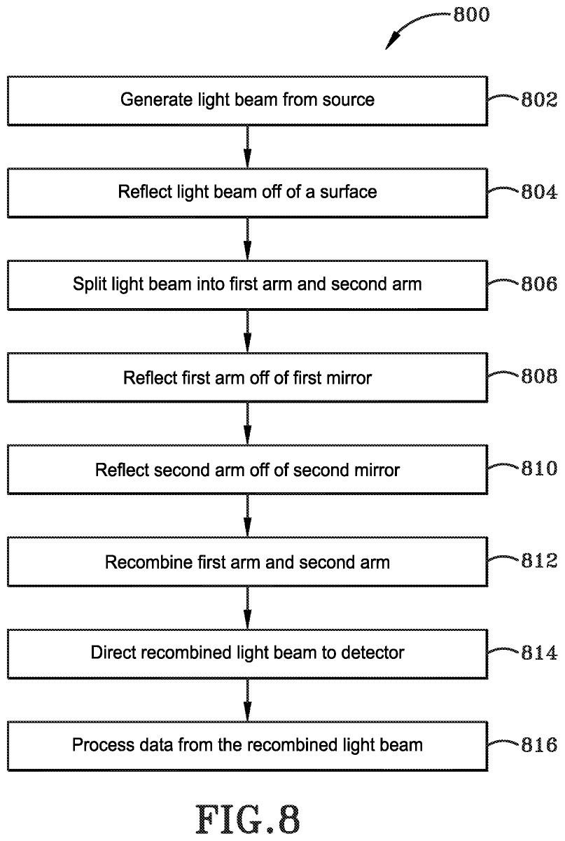

With reference to FIG. 8, an exemplary flow chart is shown depicting and exemplary method of use for an improved beam splitter as discussed herein. This method is a general method of performing shearography utilizing a Michelson interferometer; however, it will be understood that other processes and/or systems utilizing a beam splitter device may be adapted for use with the beam splitter device as described herein. Further, as Michelson interferometers have other uses besides interferometry and interferometry may be performed with devices other than a Michelson interferometer, it will be explicitly understood that these methods described herein are exemplary and that other such methods may be readily adapted for use with the improved beam splitters of the present disclosure.

The method depicted by the flow chart in FIG. 8 is generally shown and indicated as process 800. This process 800 will be illustrated using beam splitting system 100 as discussed previously herein; however, this process is also illustrated utilizing a higher refractive index such as utilizing optical medium 324. Therefore, as discussed herein, references to beam splitter 112 will be understood to utilize optical medium 324 with a higher refractive index as discussed above unless specifically stated otherwise.

The first step in process 800, indicated as step 802, involves generating light from the light source 114 and directing it into the beam splitter 112. When used for interferometry, such as in applications seeking detection of buried objects or in applications where it is desired to measure changes in a surface, the light beam 138 may be directed from light source 114 off of a relevant surface such as a ground surface or the surface of the object being tested before being directed into beam splitter 112. The reflection of light beam 138 off of an associated surface is indicated as step 804 in process 800.

Once the light beam 138 enters beam splitter 112 it may encounter splitting surface 122 wherein at least a portion of the light beam 138 may be directed to the first mirror 116 down first arm 140 following light path BB while at least another portion of the light beam 138 may pass through the splitting surface 122 and follow beam path CC along second arm 142. Splitting the light beam into first arm 140 and second arm 142 is indicated as step 806.

The first arm 140 of light beam 138 may reflect off of first mirror 116 and be redirected back towards beam splitter 112 while the second arm 142 of beam path 138 may reflect off of second mirror 118 before being redirected back towards beam splitter 112. The light beam 138 reflecting off of first mirror 116 is indicated as step 808 while the light beam 138 reflecting off of second mirror 118 is indicated as step 810.

As each arm 140, 142 of light beam 138 re-enters beam splitter 112 and re-encounters splitting surface 122, the beam paths BB and CC may be recombined into beam path DD and directed to detector 120. The recombination of first arm 140 and second arm 142 of light beam 138 is indicated in process 800 as step 812 and the direction of light beam 138 along beam path DD to detector 120 is indicated in process 800 as step 814.

Once light beam 138 enters detector 120, the data contained therein may be processed using known methods to gather the desired information from system 100. The step of processing the data is indicated as step 816 in process 800.

Typical operations of interferometry systems follow a similar method; however, when viewing a larger surface area, multiple measurements tend to be made in standard systems across a series of time to cover more area. This is both time consuming and resource consuming as it requires additional time for each additional image taken, as well as the processing thereof. The advantages of utilizing beam splitter 112 along with the increased refractive index of the optical medium 324 allows for a larger field of view, i.e., a larger area being covered with each image or image series taken utilizing process 800. It will therefore be understood that process 800 may be repeated fewer times to cover the same or greater area than standard beam splitting systems, such as system 10, when used in performing interferometry.

When used in other beam splitting applications, the beam splitter 112 and high refractive indexed medium 324 in combination also allow for a wider field of view, which in turn allows for more area to be viewed and accurately measured utilizing fewer images and less resources for each operation thereof.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method of interferometry comprising:
generating a light beam into an interferometer having an increased field of view;
directing the light beam to a first side of a splitting surface of a beam splitter within the interferometer, the beam splitter having a height and a width, wherein the height of the beam splitter is greater than the width of the beam splitter and the increased field of view of the interferometer is accomplished by the height of the beam splitter being greater than the width of the beam splitter;
dividing the light beam into a first arm and a second arm via the splitting surface;
reflecting the first arm of the light beam off a first mirror back to a second side of the splitting surface;
reflecting the second arm of the light beam off a second mirror back to the second side of the splitting surface;
recombining at least a portion of the first arm of the light beam with at least a portion of the second arm of the light beam;
directing the recombined portions of the first and second arms of the light beam to a detector; and
producing an interference pattern from the recombined portions of the first and second arms of the light beam.

2. The method of claim 1 wherein the height of the beam splitter is at least twice the width of the beam splitter.

3. The method of claim 2 wherein the beam splitter further comprises:
a length equal to the width of the beam splitter.

4. The method of claim 1 wherein the beam splitter further comprises:
an optical medium having the splitting surface immersed therein.

5. The method of claim 4 further comprising:
increasing the field of view of the interferometer by increasing a refractive index of the optical medium.

6. The method of claim 1 further comprising:
angling one of the first mirror and the second mirror to introduce interference patterns into a wavefront of the light beam.

7. An interferometer comprising:
a light source operable to deliver a light beam into the interferometer;
a beam splitter having a splitting surface immersed in an optical medium, a height, and a width, wherein the height of the beam splitter is greater than the width of the beam splitter;
a first mirror;
a second mirror; and
a detector.

8. The interferometer of claim 7 wherein the light source further comprises:
a laser generator operable to deliver a coherent laser beam into the interferometer.

9. The interferometer of claim 7 wherein the height of the beam splitter is at least twice the width of the beam splitter.

10. The interferometer of claim 7 further comprising:
an increased field of view via the height of the beam splitter being greater than the width of the beam splitter.

11. The interferometer of claim 7 further comprising:
an increased field of view via an increased refractive index of the optical medium having the splitting surface immersed therein.

12. The interferometer of claim 7 further comprising:
an increased field of view via both the height of the beam splitter being greater than the width of the beam splitter and an increased refractive index of the optical medium having the splitting surface immersed therein.

13. The interferometer of claim 7 wherein one of the first mirror and the second mirror is movable to introduce an interference pattern into a wavefront of the light beam.

14. The interferometer of claim 7 wherein the splitting surface further comprises:
a first splitting surface operable to direct a first portion of the light beam 90° to one side of the beam splitter and further operable to allow a second portion of the light beam to travel through the first splitting surface.

15. The interferometer of claim 14 wherein the beam splitter further comprises:
a second splitting surface behind the first splitting surface operable to recombine the first portion of the light beam with the second portion of the light beam after the first portion of the light beam reflects off of the first mirror and the second portion of the light beam reflects off of the second mirror.

16. A beam splitter comprising:
a splitting surface immersed in an optical medium;
a top surface connected to at least one side;
a bottom surface connected to the at least one side and spaced apart from the top surface by the at least one side;
a height defined by the distance from the top surface to the bottom surface; and
a width defined by a width of the at least one side; wherein the height of the beam splitter is greater than the width of the beam splitter.

17. The beam splitter of claim 16 wherein the height is at least twice the width of the at least one side.

18. The beam splitter of claim 16 further comprising:
an increased field of view via the height of the beam splitter being greater than the width of the beam splitter.

19. The beam splitter of claim 16 further comprising:
an increased field of view via an increased refractive index of the optical medium having the splitting surface immersed therein.

20. The beam splitter of claim 16 further comprising:
an increased field of view via both the height of the beam splitter being greater than the width of the beam splitter and an increased refractive index of the optical medium having the splitting surface immersed therein.
